(19) United States
(12) Patent Application Publication
(10) Pub. No.: US 2024/0099294 A1
(43) Pub. Date: Mar. 28, 2024

(54) WING DECOY

(71) Applicant: Eugene W. Ivy, Portland, OR (US)

(72) Inventor: Eugene W. Ivy, Portland, OR (US)

(21) Appl. No.: 18/369,504

(22) Filed: Sep. 18, 2023

Related U.S. Application Data
(60) Provisional application No. 63/409,132, filed on Sep. 22, 2022.

(51) Int. Cl. A01M 31/06

(52) U.S. Cl. CPC A01M 31/06

(57) ABSTRACT

A hunter-operated and hunter-controllable wing decoy that includes a wing shaped and sized to mimic a bird's wing and a mechanical control cable having an outer conduit and an inner core that is moveable within the outer conduit, with an actuator connectable to the wing and connected to an actuator end of the control cable, the actuator and control cable configured to move the wing in relation to the actuator in response a hunter manipulating the control cable to mimic a motion of a bird's wing. The manually operated wing decoy may be used with a number of static, non-controlled decoys, and is designed to disassemble into a collapsed secured unit for easy carrying by the hunter.

### CROSS-REFERENCE TO RELATED APPLICATIONS

The present application claims priority to U.S. Provisional Application No. 63/409,132, entitled “WING DECOY,” and filed on Sep. 22, 2022. The entire contents of the above-listed application is hereby incorporated by reference for all purposes.

### TECHNICAL FIELD

The technical field of invention relates to wing decoys. More particularly, the present invention pertains to methods and designs for a hunter-operated and hunter-controllable wing decoy that is collapsible for easy set up, disassembly, and carrying by a hunter.

### BACKGROUND AND SUMMARY

Several jurisdictions prohibit the use of electrically powered or automatic hunting decoys, such as, for example, battery powered or solar powered wing (or bird wing shaped) hunting decoys whereby at least a portion of the decoy moves in response to electrical or other (automatic) powered means. Typically, bird hunters set out a number of so-called static decoys (i.e., decoys that may comprise material that moves in response to air or wind movement but are otherwise not controllably or automatically moveable such as by a motor with mechanical linkages and so forth). The bird hunters typically include at least one non-static or movable decoy so as to introduce motion that may be perceived by other birds (e.g., in flight) as being more realistic and less artificial. It is widely believed (and/or observed) that birds in flight will not take notice of a field of static type decoys (or those which have movements that are merely in response to wind or air motion) since such decoys are likely perceived as artificial; whereas birds in flight will take notice of more realistic wing movements in one or more ground-based decoys, and, accordingly, more closely approach the decoys that comprise motion perceived to be more realistic and natural. However, many state and county governmental jurisdictions prohibit decoys that incorporate motors or automatic means for generating motion.

Other designs for wing decoys that include a capability of non-wind/air driven motion/movement, comprise anchoring the decoy to the ground and cords extending from the anchored decoy that, when pulled, cause motion in portions of the ground-anchored decoy. Such decoys are operated by a hunter pulling on the cords to cause the decoy to move. However, such decoys require that the decoy is anchored to the ground in a fixed position relative to the hunter; and such decoys require that the hunter pull against the anchored decoy, thus necessarily requiring a fixed positional relationship between the hunter and the anchored decoy, requiring essentially a straight line between the anchored decoy and the hunter for operation of the decoy, and requiring operation of the anchored decoy via pulling or applying tension on one or more cords extending from the anchored decoy.

Existing hunting wing decoy designs, therefore, have disadvantages in terms of meeting local and state governmental (jurisdictional) requirements, cost, complexity of design, ease of use, feature content, method of recommended and actual use, form factor and ergonomics of the device, design aesthetics, and/or other factors. What is needed are designs for a wing decoy, that address one or more disadvantage of existing designs.

The inventor identified the above issues and discovered innovative structures and methods to at least partially solve them. In one example, the inventor came up with a hunter-operated and hunter-controllable wing decoy that includes a wing that is shaped and sized to mimic a bird's wing and a mechanical control cable having an outer conduit and an inner core that is moveable within the outer conduit, with an actuator connectable to the wing and connected to an actuator end of the control cable, whereby the actuator and control cable are configured to move the wing in relation to the actuator in response a hunter manipulating the control cable to mimic a motion of a bird's wing. The resulting manually operated wing decoy may be used with a number of static, non-controlled decoys (each of which may comprise, for example, only a wing portion and rod connected thereto for staking into the ground); and the resulting manually operated wing decoy is designed so as to disassemble into a collapsed secured unit for easy carrying by the hunter.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

For a more complete understanding of the present invention, the drawings herein illustrate examples of the invention. The drawings, however, do not limit the scope of the invention. Similar references in the drawings indicate similar elements.

FIG. 1 is a top perspective view of a wing decoy, according to various embodiments.

FIG. 2 is a top isometric view of the wing portion of the decoy, according to various embodiments.

FIG. 3 is a bottom isometric view of the wing portion of the decoy, according to various embodiments.

FIG. 4 depicts a cross-sectional view of a rod bracket of the wing decoy shown in FIG. 3, according to various embodiments.

FIG. 5 depicts a pair of rods with connector tube, according to various embodiments.

FIG. 6 is a side isometric view of the wing decoy mechanical base or actuator, according to various embodiments.

FIG. 7 is a back isometric view of the wing decoy mechanical base, according to various embodiments.

FIG. 8 is a conceptual view of the wing decoy actuating system, according to various embodiments.

FIG. 9 illustrates a user actuating the control cable of the wing decoy, according to various embodiments.

FIG. 10 is a perspective view of the wing decoy, according to various embodiments.

FIG. 11 is a back view of the wing decoy in the down position, according to various embodiments.

FIG. 12 is a front perspective view of the wing decoy mechanical base, according to various embodiments.

FIG. 13 is a side view (i.e., a left side view) of the wing decoy mechanical base, according to various embodiments.

FIG. 14 is a top down view of the wing decoy mechanical base/actuator while in the down position, according to various embodiments.

FIG. 15 is a top down view of the wing decoy mechanical base/actuator while in the up position, according to various embodiments.

FIG. 16 depicts rod portions clipped in the stored position, according to various embodiments.

FIG. 17 depicts the left side of the wing decoy actuator with rod portions and control cable in the stored position, according to various embodiments.

FIG. 18 illustrates a control cable protection sleeve of the wing decoy, according to various embodiments.

FIG. 19 illustrates a cotter pin connecting the rod to the wing decoy mechanical base or actuator, according to various embodiments.

FIG. 20 depicts the right side of the wing decoy in the stored position, according to various embodiments.

FIG. 21 illustrates a closed travel bag for the wing decoy, according to various embodiments.

### DETAILED DESCRIPTION

The above-described figures illustrate various aspects of a wing decoy, according to various embodiments. Different embodiments are shown, and different aspects of the different embodiments may be combined together to comprise embodiments of a wing decoy that are not, in such combination of features, fully represented in any one or any particular subset of the figures. For example, the cotter pin attachment of a rod portion (connecting an actuator with a wing material) may be incorporated in any of the embodiments illustrated and described or any combination of features described herein for a wing decoy so as to comprise a complete wing decoy assembly. Furthermore, each of the features described herein may be separable on its own, whereby the separable feature (whether an apparatus or method) is novel and innovative on its own and may be incorporated into other than a wing decoy per se. For example, an apparatus comprising an assembly having a control cable (as described, claimed, and illustrated herein) and an actuator (as described, claimed, and illustrated herein) is novel and innovative and, although described in the context of a wing decoy, may be used in systems, devices, and methods other than systems, devices, and methods involving a wing decoy.

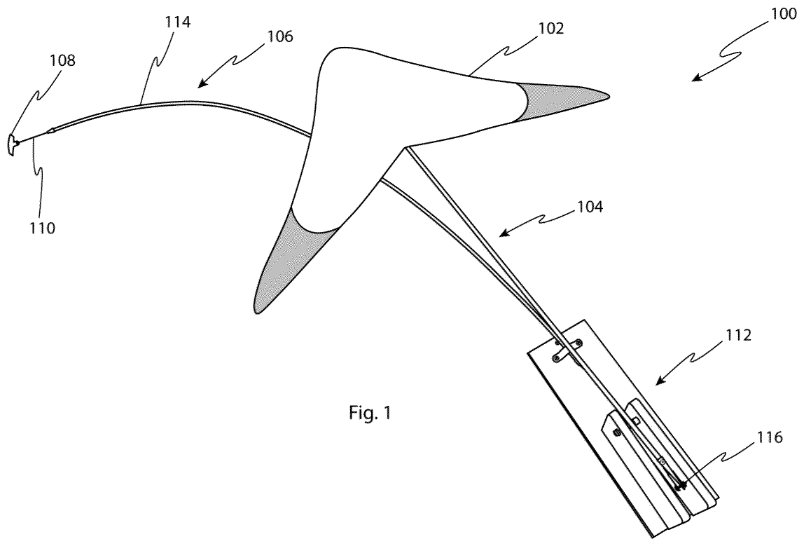

As an overview, FIG. 1 illustrates a hunter-operated and hunter-controllable wing decoy that includes a wing 102 shaped and sized to mimic a bird's wing and a mechanical control cable 106 having an outer conduit 114 and an inner core 110 that is moveable within the outer conduit 114, with an actuator 112 connectable to the wing 102 and connected to an actuator end 116 of the control cable 106, the actuator 112 and control cable 106 configured to move the wing 102 in relation to the actuator 112 in response to a hunter 902, 904 manipulating the control cable 106 to mimic a motion of a bird's wing. The manually operated wing decoy may be used with a number of static, non-controlled decoys, and is designed to disassemble into a collapsed secured unit for easy carrying by the hunter.

FIG. 1 is a top perspective view of a wing decoy 100, according to various embodiments. The wing decoy 100 preferably comprises a wing 102 connected via a rod 104 to the actuator 112. As shown, the control cable 106 comprises of an inner core 110 within an outer conduit 114, where the inner core 110 can move within the outer conduit 114. The inner core 110 is movable via the handle 108 and the other end of the inner core 110 is connected to the actuator end 116.

As is further described below, an operator or user (e.g., a hunter) may be, for example, positioned near the handle 108 (e.g., at a front of the wing decoy 100) for manual operation of the actuator 112 (e.g., at a rear or back end of the wing decoy 100) so as to move the wing 102 upward by pulling the handle 108 to toward the user, or downward by pushing the handle 108 away from the user, with a pulling action causing the inner core 110 to move toward the user (with respect to the outer conduit 114) and a pushing action causing the inner core 110 to move away from the user (again, with respect to the (e.g., stationary) outer conduit 114).

As shown in FIG. 1, with an operator/user positioned at a front end of the wing decoy 100 (i.e., near the handle 108), the control cable 106 extends from the front or handle end of the wing decoy assembly, rearward to a front edge/end of the actuator 112, with a rearward or back end or edge of the actuator 112 being positioned opposite the handle or front end of the wing decoy 100 assembly, and with the wing 102 therebetween, extending forward toward the operator/user/hunter via the rod 104 affixed to the wing 102. Attempts are made in the description herein to refer to various sides and perspectives of the actuator 112 from the vantage point/perspective of a user/operator/hunter positioned at a handle end or front end of the wing decoy assembly.

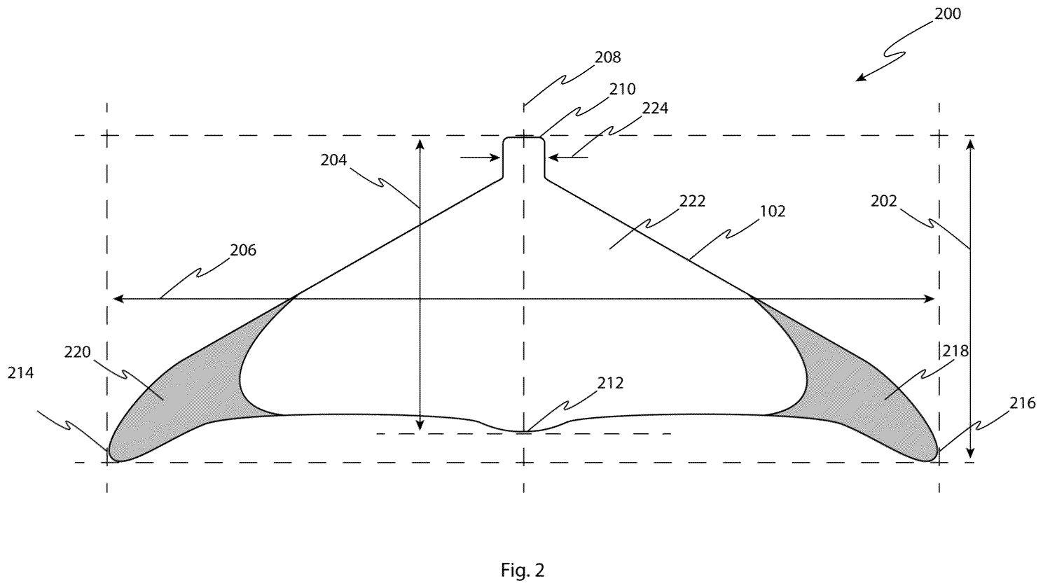

FIG. 2 is a top isometric view 200 of the wing portion 102 of the decoy, according to various embodiments. Wing 102 is preferably a triangular or bird shaped material having a length 202, 204 and a width 206 and made from a semi-rigid material, closed cell foam, and/or EPE foam. The top of the wing 200 shows how the top preferably has colored portions 218, 220 at the wingtips and a main, different color (likely white), portion 222. The wing 102 has a front edge 210 with front width 224, left most edge 214, right most edge 216. The bottom edge 212 is at the bottom of the main portion of the wing 222, perpendicular to the lengthwise centerline 208. The center length of the wing 204 is the distance between 212 and 210.

Exemplary dimensions for length (fore to aft) 202 of the wing 102 (or the distance 210-216 or 210-214), center length 204 (fore to aft, along center line 208) of the wing (or the distance 210-212), width 206 (left wing tip to right wing tip) of the wing (or the distance 214-216), and width 224 (side to side) of the front edge 210 of the wing may be 20 inches, 19 inches, 45 inches, and 2.5 inches, respectively.

The color pattern of the wing 102 may be symmetric about the center line 208, as shown, or not. For example, as shown in FIG. 2, wing tip areas 218, 220 may be mirror images of each other about the center line 208, and may comprise blackened color to contrast with a central or main (white colored) portion 222 of the wing 102. Such a pattern (as shown in FIG. 2) may mimic a color pattern and scheme of snow geese. Other patterns or different colors may be used. For example, colors and patterns may be chosen that are intended to mimic the wing colorations and pattern of Canadian geese, mallard wings, pintail wings, or others.

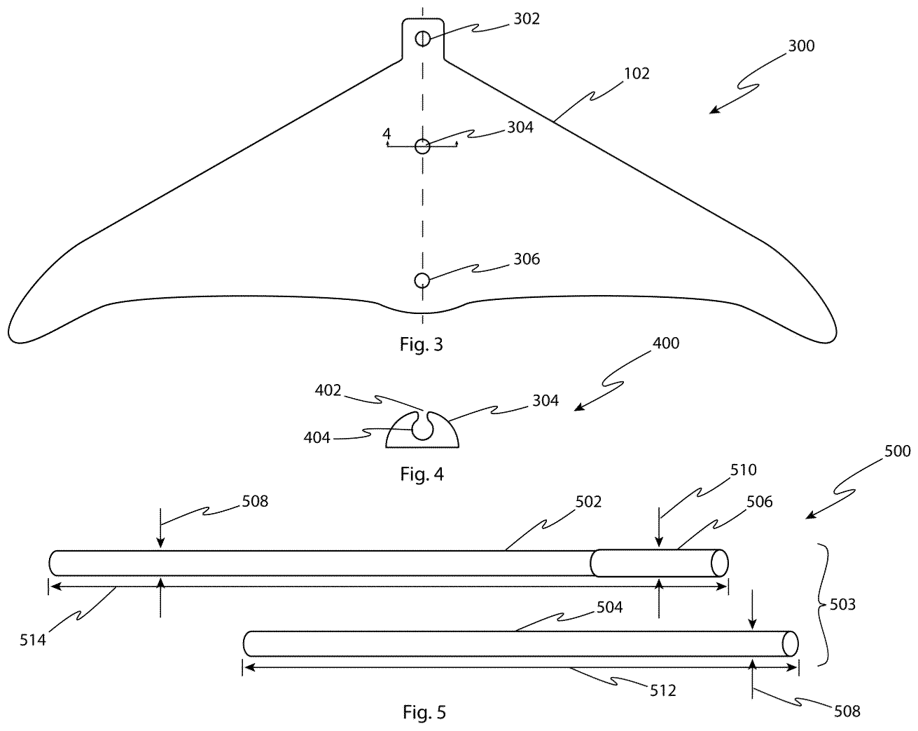

FIG. 3 is a bottom isometric view 300 of the wing portion 102 of the decoy, according to various embodiments. The wing 102 may comprise multiple brackets 302, 303, and 304 to connect the wing 102 to rod 104. A color pattern/scheme for the surface of the bottom of wing 102 (as shown in FIG. 3) may be all white, or another pattern or other color schemes may be used to mimic different wing appearances.

FIG. 4 depicts a cross-sectional view 400 of a rod bracket 304 of the wing 102 shown in FIG. 3, according to various embodiments. The rod brackets 304, 302, 306 may each comprise passive clamps such as passive clamp 402 and space/holder 404 for a diameter of a rod such as rod 104.

The opening/space/holder 404 may be sized to receive a diameter of the rod 104 so as to resiliently retain the passive clamp 402 (and the wing 102 affixed thereto) to the rod 104, with enough grip strength so as to allow the rod 104 to be moved upward and downward (via the actuator 112 and the control cable 106 configured therewith). The passive clamps may, for example, permit a rod (such as rod 104) to snap into or slide into the space 404. Such clamps 304, 302, 306 may be adhered or otherwise affixed to the wing 102 material and may comprise a plastic or rubberized material, or similar construction, or, alternatively, different means for attaching the rod to the wing may be used.

FIG. 5 depicts a pair of rods (rod assembly) 500 with connector tube, according to various embodiments. The set of rod portions 503 may comprise rod portions 502 and 504, each with a rod diameter 508 and a length 512, 514. Rods 502 and 504 can be connected to one another via rod connector tube 506 which may have an appropriately corresponding connector diameter 510 depending on a rod diameter 508; note that 514, as shown, is a length of the rod and connector combined according to embodiments. Rod 104 (or a rod/rod assembly connecting a wing 102 to an actuator 112) may include, in one embodiment, rod assembly 500. Rod 104 may also be one piece, as shown in FIG. 1, or may comprise portions that disassemble, for example rod portions 502, 504 and connector tube 506, in order to collapse down the disassembled wing decoy assembly into smaller, more compact components.

Exemplary dimensions for rod diameter 508, connector tube diameter 510, length 512 of rod portion 504, and length 514 of rod portion 502 plus connector 506 may be ⅜ inch, just over ⅜ inch (so that inside diameter of the connector tube 506 is ⅜ inch), 26 inches, and more than 26 inches (to include at least a portion of a connector tube 506 having a length of 2.5 inches), respectively.

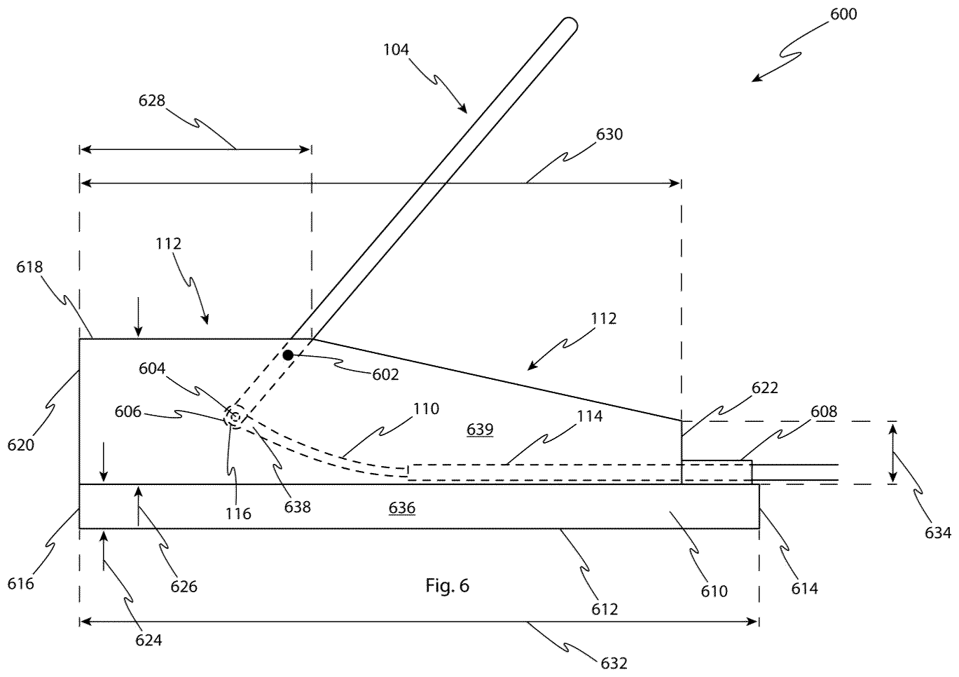

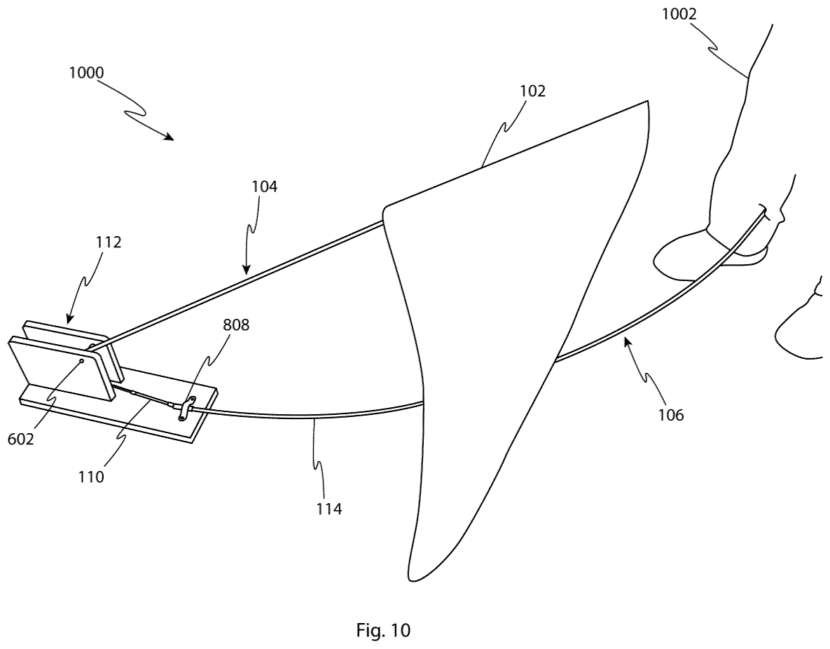

FIG. 6 is a side isometric view 600 of the wing decoy mechanical base or actuator 112, according to various embodiments. For example, FIG. 6 shows a left sided view of the mechanical base of the wing decoy. To describe the figures more effectively, attempts are made herein such that component orientations/descriptions/definitions with direction are from the view/viewpoint/vantage point of the operator facing the wing decoy assembly from the front (see FIG. 10). From this view the structure of the mechanical base comprises: the bottom of mechanical base 612, the back face of the bottom block 616, the left side block top face 618, the front face of the left side block 622, the bottom block's height 624, the side blocks height at the back of the mechanical base 626, the length of the top of the side blocks 628, the total length of the side blocks 630, the length of the bottom block 632, the side blocks height at the front of the mechanical base 634, the left face of the bottom block 636, and the left face of the left side block 639.

The mechanical base comprises the housing/structure for actuator 112 and the various components of actuator 112. The control cable 106 is fastened with fastener 608 to top face of the bottom block 610 towards the front face 614, the front of the mechanical base. Control cable 106 runs down the center of the mechanical base towards the back face 620 of the mechanical base. Before reaching pivot 604, the outer conduit 114 of the control cable 106 ends while the inner core 110 continues into a yoke connector (clevis fastener) 638 at the actuator end of the control cable 116. At pivot 604 the tang 606 (the actuator end of rod 104) is fastened into, but able to rotate about, the yoke 638. Rod 104 is also connected, but able to rotate about, pivot bolt 602.

Exemplary dimensions for the bottom block height 624 (or the dimension 614-616), side block height at the back 626 (or a back/rearward end height of the left face of the left side block 639), the length of the top of the side blocks 628 (or a distance between the back end/face 620 and a point forward along the actuator 112 where the height of the face of side block 639 begins to taper downward toward the face of the bottom block 636), the total length of the side block 630 (or a distance 620-622), the length of the bottom block 632 (or a distance 616-614), and the height of the side blocks at the front 634 (or a height of a front face 622 of the side block) may be ⅝″, 5½″, 4½″, 19″, 21″, and 2¼″, respectively.

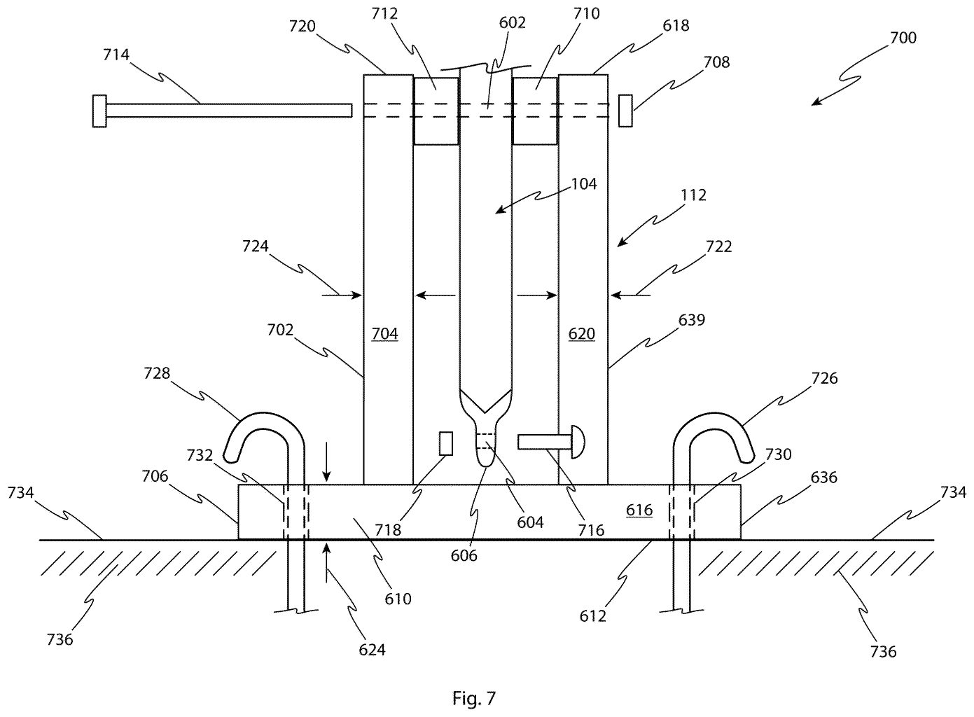

FIG. 7 is a back isometric view 700 of the wing decoy mechanical base, according to various embodiments. From this view the structure of the mechanical base comprises: The back face of the left side block 620 and of right side block 704 with thickness 722, 724, the top face of the left side block 618 and the right side block 720, the bottom block 610 which sits on the ground surface 734, the bottom blocks back face 616, the outside face of the right side block 702 and of the left side block 639, and the right and left faces of the bottom block 636, 706.

This view also depicts how the actuator 112 assembly may be housed between the two side blocks. Pivot 602 comprises a bolt 714 that passes through both side blocks, rod 104, bushings 710, 712, and is secured at the other side with lock nut 708, allowing rod 104 to rotate about 602 effectively. Pivot 604 comprises a screw 716 that passes through the yoke 638, the tang 606 of rod 104, and is secured at the other end of the yoke by a nut 718. FIG. 7 also shows the use of stakes 726, 728 beings used to secure the mechanical base to the ground 736; in this embodiment the stakes 726, 728 would be passed through pre-made holes 730, 732 in the bottom block 610 into the ground 736.

Exemplary dimensions for side block thickness 722, 724 and height 624 of the back face 616 may each be ⅝ inch, or one inch. Bolt 714 may be a ¼ inch diameter bolt which mates with a ¼ diameter lock nut 708. Screw 716 may be a 5/16 inch diameter machine screw which mates with a correspondingly sized nut 718. The bushings 712, 710 may be sized to be one inch in diameter by ½ inch width.

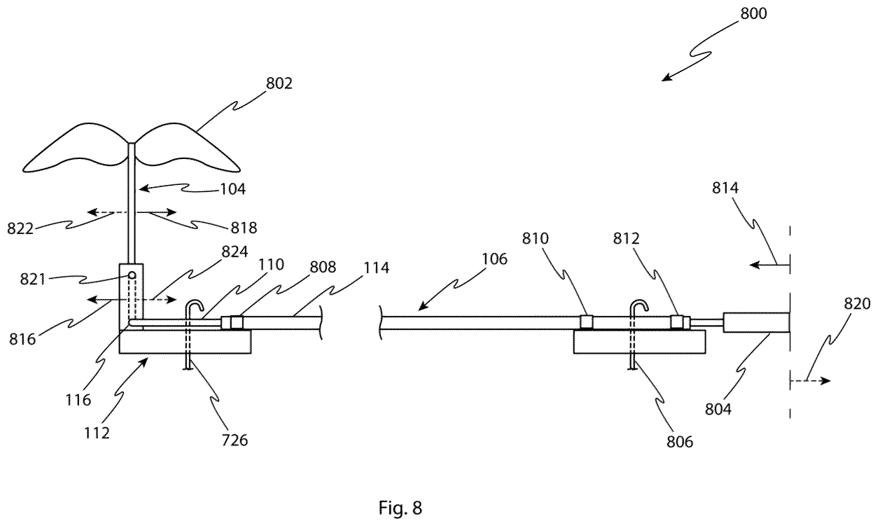

FIG. 8 is a conceptual view of the wing decoy actuating system 800, according to various embodiments, showing how the wing 802 moves based on input at the pull handle 804. Pushing 814 the pull handle 804 causes the actuator end 116 of the control cable 106 to move in the corresponding direction 816 causing rod 104 to rotate about pivot 821 causing the wing end of 104 and wing 802 to move downwards 818. Pulling 820 the pull handle 804 causes the actuator end 116 of the control cable 106 to move in the corresponding direction 824 causing rod 104 to rotate about pivot 821 causing the wing end of 104 and wing 802 to move upwards 822.

The view in FIG. 8 also shows one embodiment where one or more fastener 810, 812 secures the control cable 106 to a block which may optionally be secured to the ground via stake 806 near the operating end (but on an outer conduit 114 portion of the control cable 106), and fastener 808 is used to secure the other end of the control cable 106 to the mechanical base. This embodiment essentially mounts the outer conduit 114 so that input from the pull handle 804 will only move the inner core 110, allowing a hunter to only use one hand to operate the wing decoy because. Note that this is optional and other embodiments replace this with a grip for the hunters other hand.

Notably, the actuator 112 need not be secured to the ground as (optionally) shown in FIG. 8. That is, the wing decoy assembly 100 (or wing decoy actuating system 800) is fully operable with all components of the wing decoy assembly being free standing and not additionally or optionally secured to the ground using one or more stake, such as shown in FIGS. 7 and 8 using stakes 726, 728, and 806. The present inventor determined that the wing decoy assembly comprising a control cable and actuator, as shown in FIG. 1, permits operation of the wing decoy assembly (i.e., placement of the decoy and operating the decoy to mimic motion of the wing) without having to position the actuator in a straight line arrangement from the user/operator/hunter, without having to secure any portion of the decoy (such as, for example the actuator 112) to a ground surface supporting the decoy assembly, and without the use of a motor or other automated or electrified means of controlling and manipulating motion of the wing portion of the decoy assembly.

Exemplary dimensions for the control cable 106 may comprise a diameter of ¼ inch for the outer conduit 114 and a length of between 20 feet and 40 feet for the control cable 106 (from the actuator 112 to the operating/pull handle 804).

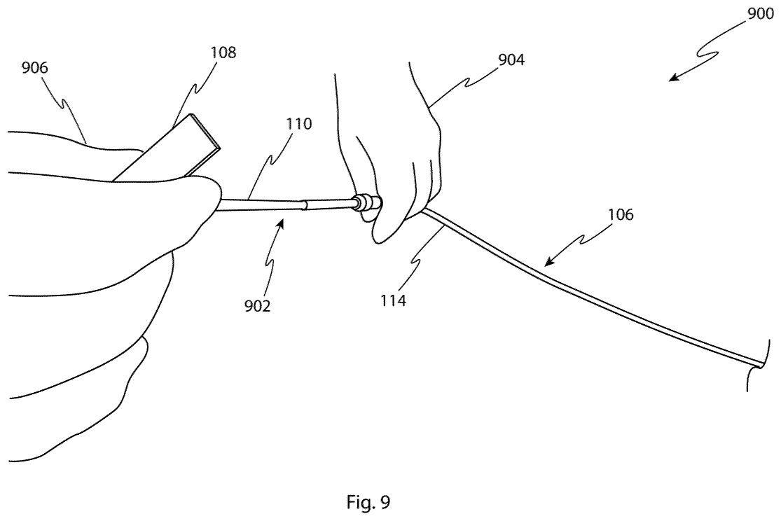

FIG. 9 illustrates a user actuating the control cable of the wing decoy, according to various embodiments. Example use 900 shows the operating end 902 of the control cable 106 in use according to preferred embodiments. One hand 906 (of an operator/hunter) is holding the pull handle 108 and the other hand 904 is holding the outer conduit 114 portion of the control cable 106. Note that other embodiments have a handle or grip at the same position as hand 904 for ease of use.

FIG. 10 is a perspective view 1000 of the wing decoy, according to various embodiments. This figure shows the full wing decoy assembly in the up position and in relation to an operator/user/hunter 1002. Operator 1002 is facing the front of the wing decoy and is holding the control cable 106. Control cable 106 connects to the mechanical base with a fastener 808 securing the outer core 114 to the mechanical base. The outer core stops and the inner core 110 continues to connect to the actuator 112. Rod 104 is connected to actuator 112 and 602 at/near one end and at the other end wing 102 is connected.

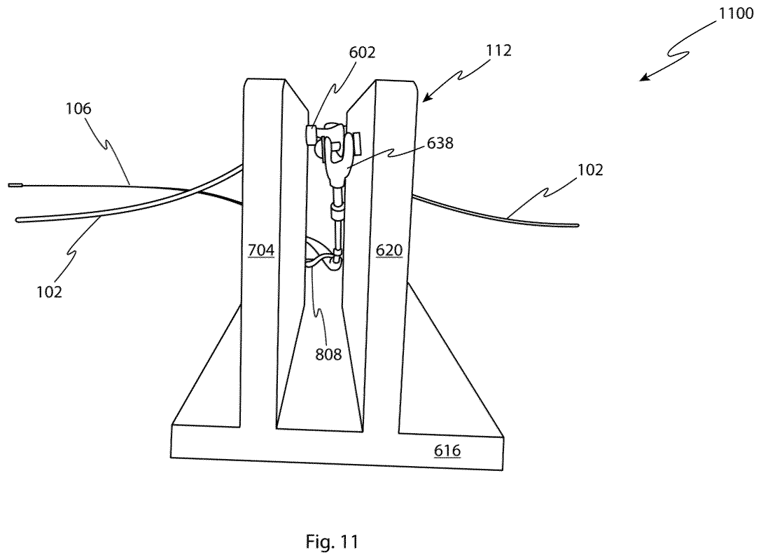

FIG. 11 is a back view 1100 of the wing decoy in the down position, according to various embodiments.

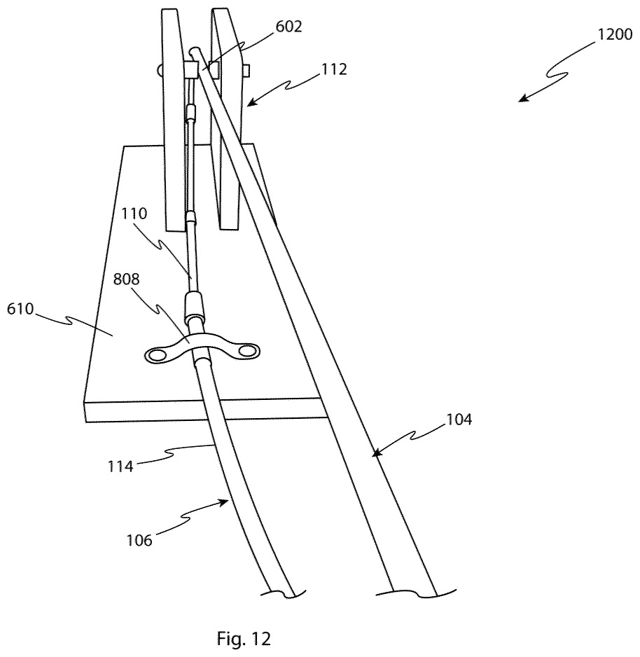

FIG. 12 is a front perspective view 1200 of the wing decoy mechanical base/actuator 112, according to various embodiments.

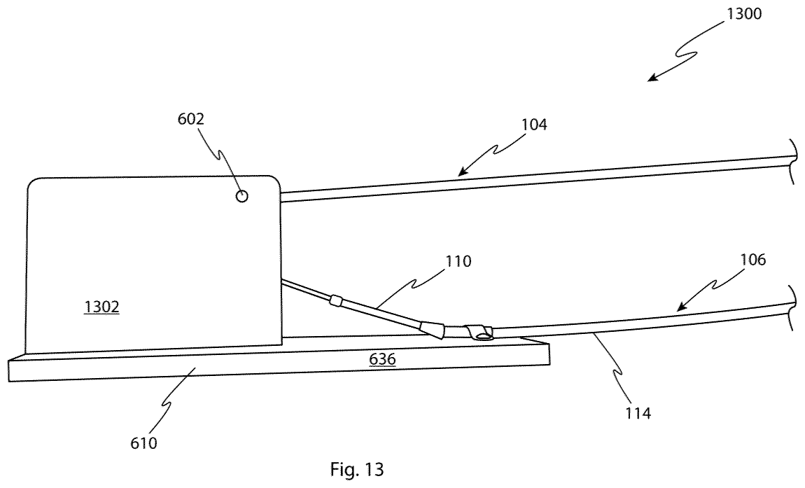

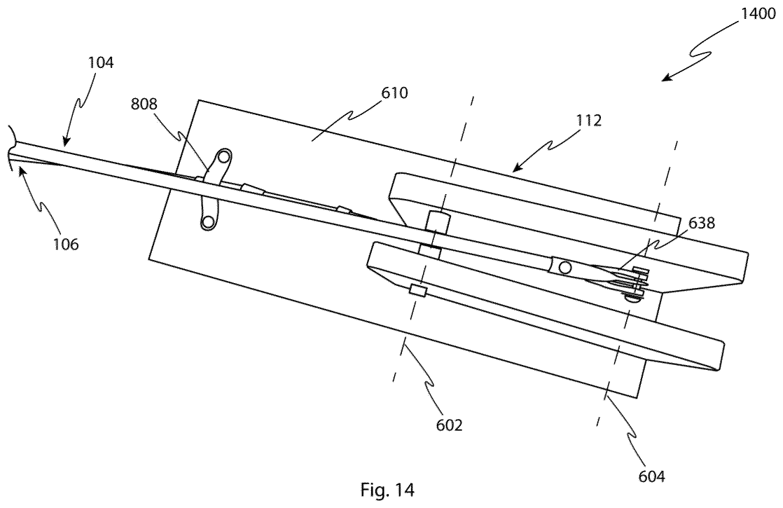

FIG. 13 is left side view 1300 of the wing decoy, according to various embodiments. This embodiment shows an alternative shape for the actuator side blocks 1302. Note that this shows that though changes can be made to the shape, the overall structure may be similar to provide the desired functionality. For example, bolt pivot 602 should be near the top front of the side block 1302 (as shown).

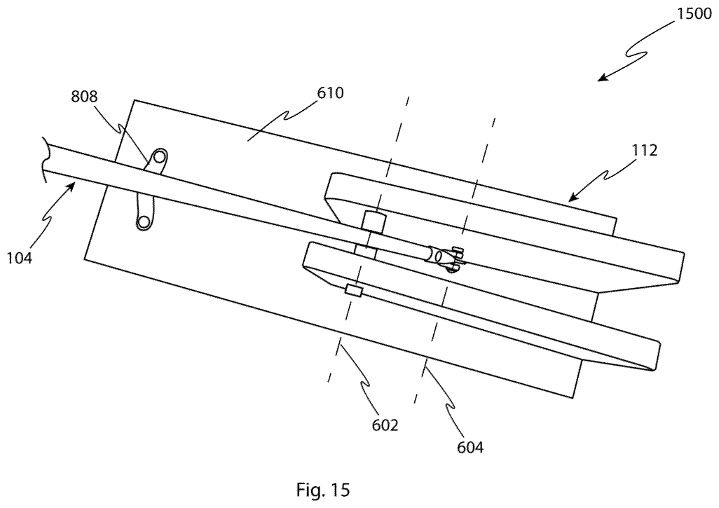

FIG. 14 illustrates the wing decoy while in the down position 1400, according to various embodiments. Note how bolt 602 may pass through rod 104 and the side blocks, as shown, and how pivot point/pivot axis 604 may connect to the end of rod 104 and the yoke 638 which is connected to the control cable. Also note the relationship between bolt/pivot point/pivot axis 602 (pivot point of rod 104) and pivot point/pivot axis 604 (pivot between actuator end of control cable 116 and end of rod 606) and how the distance between them (i.e., between the two pivot points 602, 604) from a top down perspective can show what position the wing is in.

FIG. 15 illustrates the wing decoy in the up position 1500, according to various embodiments. Note how bolt 602 may pass through rod 104 and the side blocks, as shown, and how pivot point/pivot axis 604 connects to the end of rod 104 and the yoke 638 which is connected to the control cable. Also note the relationship between bolt/pivot point/pivot axis 602 (pivot point of rod 104) and pivot point/pivot axis 604 (pivot between actuator end of control cable 116 and end of rod 606) and how the distance between them (i.e., between the two pivot points 602, 604) from a top down perspective can show what position the wing is in.

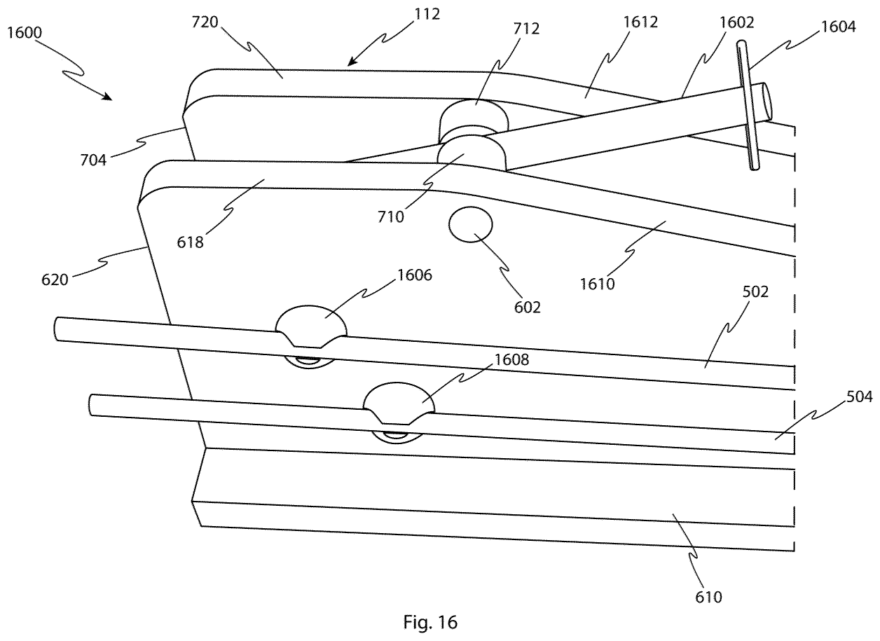

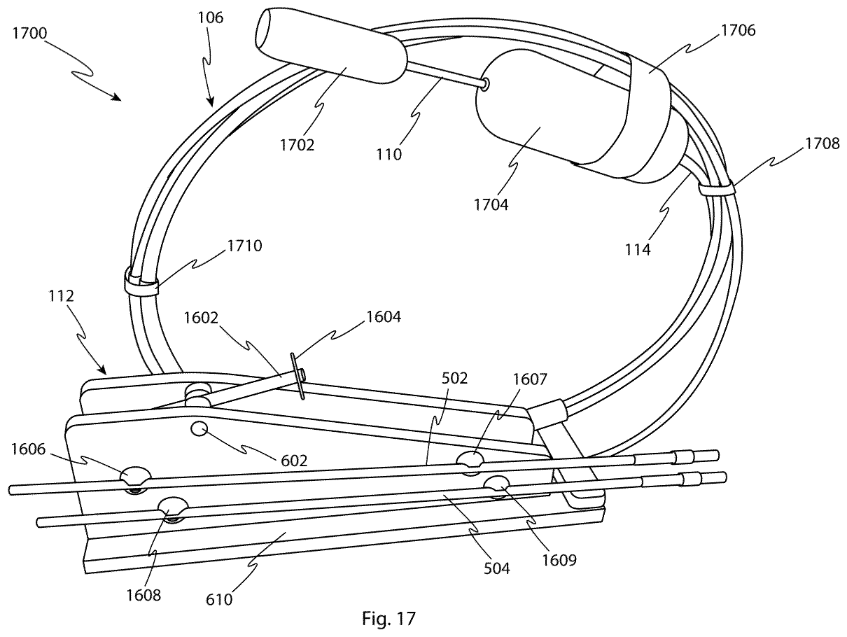

FIG. 16 depicts rod portions clipped in the stored position 1600 on the mechanical base/actuator 112, according to various embodiments. In this embodiment connector tube 1602 takes place of rod 104 in the actuator assembly such that rod 104 can be easily attached and removed via this tube 1602 and a cotter pin 1604, making setup and disassembly easier. This embodiment also includes clips 1606, 1608 which can store rods 1606, 1608. Note that the rods 1606, 1608 may be assembled to become a rod 104.

Exemplary dimensions for the connector tube 1602 may comprise a length of nine inches and a diameter sized to securely receive a rod portion 502, 504.

FIG. 17 depicts the left side of the wing decoy actuator with rod portions and control cable in the stored position, according to various embodiments. The stored wing decoy 1700 utilizes a big strap 1706 to keep the control cable 106 and handle portion 1704 coiled together. It also utilizes smaller straps 1708 and 1710 to keep the rest of the cable coiled. This embodiment also includes two more rod clips 1607 and 1609 for rod storage. This embodiment also has an example pull handle 1702 featured.

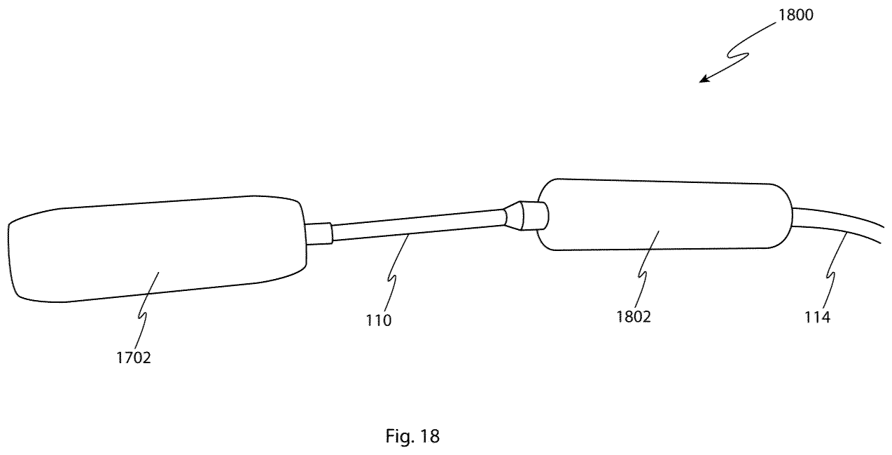

FIG. 18 illustrates a control cable protection sleeve of the wing decoy, according to various embodiments. 1800 is a close up of the operating end 902 of the control cable 106. The operating end close up 1800 depicts a protection sleeve/grip on the outer conduit 114 portion at the operating end 902 of the control cable 106. Also, pull handle 1702 is depicted connecting to the inner core 110 which enters the outer conduit 110 near the protective sleeve 1802.

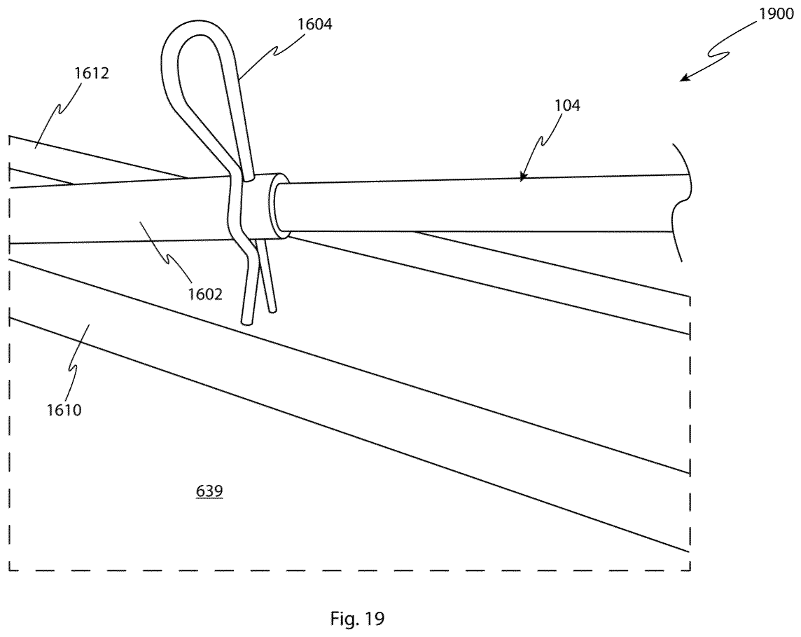

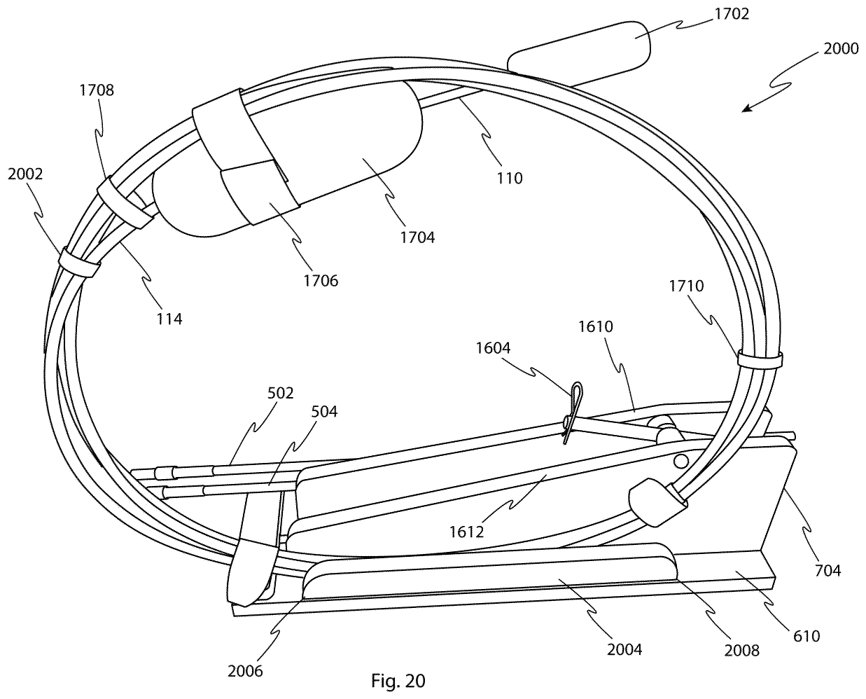

FIG. 19 illustrates a cotter pin connecting the rod to the wing decoy mechanical base or actuator, according to various embodiments. 1900 is a close up of the rod connecting the wing to the mechanical base which comprises of a cotter pin 1604, connector tube 1602, and rod 104 connected to the connector tube 1602 using cotter pin 1604 to ensure rod 104 doesn't fall out.

FIG. 20 depicts the right side of the wing decoy in the stored position, according to various embodiments. 2000 is the right side of the stored wing decoy assembly which contains many of the same aspects as FIG. 17. This view shows another block 2004 being added to the mechanical base in order to more securely store the coiled cable with the mechanical base. Block 2004 has its front end at 2006 and back end at 2008. Adding this block creates a trench between block 2004 and the right side block 1612 for the coiled up control cable 106 to sit snuggly between. This view also adds another example strap 2002 for better storage.

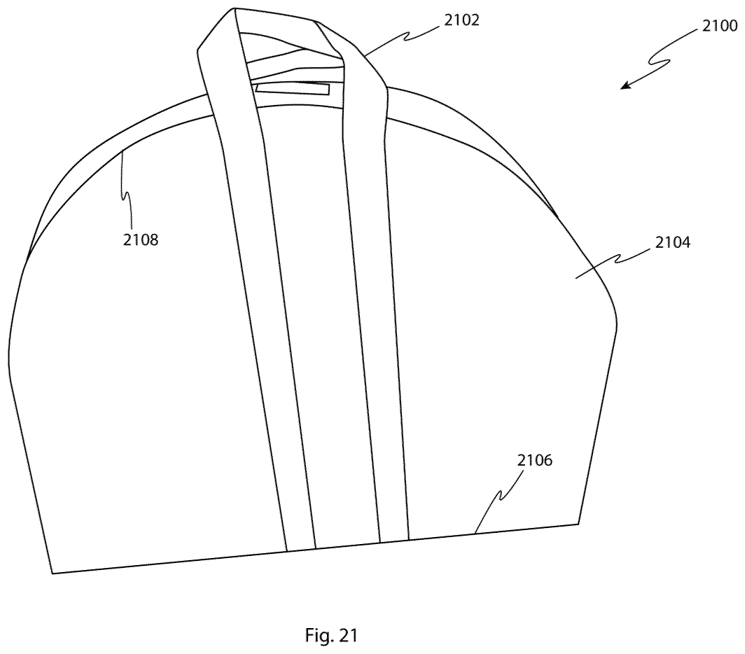

FIG. 21 illustrates a closed travel bag for the wing decoy, according to various embodiments. 2100 is a closed travel bag with a handle 2102 at the top of the bag, main material for the bag 2104, and the bottom of the bag 2106.

As described herein, the present inventor determined that existing hunting wing decoy designs have disadvantages in terms of meeting local and state governmental (jurisdictional) requirements (e.g., prohibitions for use of motorized, automated, and/or electrified decoys), cost, complexity of design, ease of use, feature content, method of recommended and actual use, form factor and ergonomics of the device, design aesthetics, and/or other factors. To address and at least partially solve such problems, the inventor invented a hunter-operated and hunter-controllable wing decoy that includes a wing 102 shaped and sized to mimic a bird's wing and a mechanical control cable 106 having an outer conduit 114 and an inner core 110 that is moveable within the outer conduit 114, with an actuator 112 connectable to the wing 102 and connected to an actuator end 116 of the control cable 106, the actuator 112 and control cable 106 configured to move the wing 102 in relation to the actuator 112 in response to a hunter 902, 904 manipulating the control cable 106 to mimic a motion of a bird's wing.

In one embodiment, a hunter-operated and hunter-controllable wing decoy 100 comprises: a wing 102 having a length 202 and a width 204; a mechanical control cable 106 having an outer conduit 114 and an inner core 110 that is moveable within the outer conduit; and an actuator 112 connectable to the wing 102 and connected to an actuator end 116 of the control cable, and configured to move the wing 102 in relation to the actuator 112 in response to movement between the inner core 110 and the outer conduit 114 of the control cable with respect to one another.

In one aspect, the control cable comprises an operating end 902 opposite the actuator end 116, whereby a hunter causes movement of the wing by, at the operating end 902 of the control cable, moving the inner 110 core of the control cable 106 with respect to the outer conduit 114, thereby causing the actuator 112 to move the wing 102 in response to the hunter causing movement 904, 906 between the inner core 110 and the outer conduit 114 of the control cable 106.

In another aspect, the wing 102 comprises triangular-shaped material or material in a shape of a bird's wing.

In another aspect, the wing 102 comprises a semi-rigid material.

In another aspect, the wing 102 comprises a closed cell foam.

In another aspect, the wing 102 comprises an EPE foam.

In another aspect, a rod 104 or a plurality of interconnectable rod portions connects the wing to the actuator.

In another aspect, the actuator 112 pivotally moves the wing up and down or in a back and forth motion in response to moving the inner core 110 in relation to the outer conduit 114 of the control cable 106.

In another aspect, the actuator 112 is configured to move the wing 102 in response to movement of the inner core 110 in relation to the outer conduit 114 of the control cable 106 without the actuator 112 anchored to a surface 734 or anchored to ground 736 situated beneath the actuator 112.

In another aspect, the actuator 112 is anchored to a surface 734 or anchored to ground 736 situated beneath the actuator 112 by one or more stakes 726, 728.

In another aspect, the control cable 106 comprises a push-pull mechanical control cable or a push-pull throttle cable.

In another aspect, the inner core 110 of the control cable 106 is made of a solid non-stranded material.

In another aspect, the wing 102 is configured to flex along its length 204 and/or width 206 dimensions when moved up and down or back and forth in response to movement between the inner core 110 and the outer conduit 114 of the control cable 106, so as to mimic wing motion of a bird.

In another aspect, the wing is repeatably detachable by a hunter 904, 906 from one or more rod portions 502, 504 connecting the wing 102 to the actuator 112, the wing is repeatably foldable and/or rollable by the hunter 904, 906 so as to reduce the wing's length 204 and/or width 206 when in a folded and/or a rolled up orientation, the one or more rod portions 502, 504 are repeatably detachable by the hunter 904, 906 from the actuator 112, and the control cable 106 is flexible to allow for repeatedly rolling or coiling the control cable by the hunter 904, 906 into a rolled up orientation with the actuator.

In another aspect, the wing 102 and the one or more rod portions 502, 504 used to connect the wing 102 to the actuator 112 are configured to disassemble from one another into a collapsed secured unit with the actuator 112 and with the control cable 106 in the rolled up orientation, the collapsed secured unit configured for carrying by the hunter.

In one embodiment, a method of using a hunter-operated and hunter-controllable wing decoy comprises: placing a collapsed secured wing decoy 100 on a ground surface, the collapsed secured wing decoy comprising the wing decoy 100 as in described above; unfolding and/or unrolling the wing; unrolling the mechanical control cable along the ground surface 734 so that the control cable connected thereto at an actuator end of the control cable extends away from the actuator to an operator end 902 of the control cable 106; attaching the wing 102 (and rod 104 affixed thereto) to the actuator 112, the unrolled control cable with actuator and wing attached thereto comprising an assembled hunter-operated and hunter-controllable wing decoy; and moving, by a hunter 904, 906 operating the control cable 106 at the operator end 902 of the control cable 106, the inner core 110 of the control cable with respect to the outer conduit 114 of the control cable 106 so as to move the wing 102 in an up and down or back and forth motion to mimic a motion of a wing of a bird.

In one aspect, the method further comprises: placing, proximate to the assembled hunter-operated and hunter-controllable wing decoy, a plurality of static wing decoys, wherein each of the plurality of static wing decoys comprises triangular-shaped material or material in a shape of a bird's wing.

In one embodiment, a kit of components for a hunter-operated and hunter-controllable wing decoy comprises: a wing 102 having a length 202, 204 and a width 206; and a mechanical control cable 106 having an outer conduit 114 and an inner core 110 that is moveable within the outer conduit 114, with an actuator 112 connectable to the wing and connected to an actuator end 116 of the control cable, the actuator and control cable configured to move the wing in relation to the actuator in response to movement between the inner core 110 and the outer conduit 114 of the control cable 106 with respect to one another.

In one aspect, the kit further comprises: a rod 104 or a plurality of interconnectable rod portions 502, 504 configured to connect the wing 102 to the actuator 112.

In another aspect, the kit further comprises: a bag 2100 sized to enclose and retain the wing 102 when folded and/or rolled up to reduce its length 202, 204 and/or width 206, the actuator 112 with the control cable 106 in a rolled up or coiled orientation, and the rod 104 or the plurality of interconnectable rod portions 502, 504 when disassembled from connecting the wing 102 to the actuator 112.

The terms and expressions which have been employed herein are used as terms of description and not of limitation, and there is no intention in the use of such terms and expressions of excluding equivalents of the features shown and described or portions thereof, it being recognized that the scope of the invention is defined and limited only by the claims which follow.

### LIST OF ALL NUMERAL REFERENCES

FIG. 1—Top Perspective View of Wing Decoy
100 wing decoy
102 wing
104 rod connecting wing to actuator
106 control cable
108 operating end/handle (of control cable)
110 inner core (of control cable)
112 actuator
114 outer conduit (of control cable)
116 actuator end (of control cable)

FIG. 2—Top Isometric View of Wing
200 top view of wing
202 full length of wing
204 center length of wing
206 width of wing
208 lengthwise center line
210 top/front edge
212 bottom edge at perpendicular to centerline (208)
214 left most edge of wing
216 right most edge of wing
218, 220 colored portions of wing on the tips
222 white portion of wing main piece of wing
224 width of wing at front edge

FIG. 3—Bottom Isometric View of Wing
300 bottom view of wing
302, 304, 306 brackets for connecting wing to a rod

FIG. 4—Detailed Rod Bracket
400 rod bracket
402 clamps
404 holder

FIG. 5—Fiberglass Rods with Connector Tube
500 rods (rod assembly)
502 rod portion (shown connected to connector tube 506)
503 set of rod portions (rod 502 with connector tube 506, and rod 504)
504 rod portion
506 connector tube
508 rod diameter
510 connector diameter
512 rod length
514 rod+connector length

FIG. 6—Left Side Isometric View
600 left side view mechanical base
602 bolt (and pivot point of rod 104)
604 pivot between actuator end of control cable 116 and end of rod 606
606 end of rod 104
608 control cable to block fastener
610 bottom block of mechanical base
612 bottom of mechanical base
614 front face of bottom block
616 back face of bottom block
618 left side block top face
620 back face of left side block
622 front face of left side block
624 bottom block height
626 side block height at the back
628 length of the top of side block
630 total length of side block
632 length of mechanical base bottom block
634 side block height at the front
636 left face of bottom block
638 yoke connecting inner core 110 to pivot point 604
639 left face of left side block

FIG. 7—Back Isometric View of Mechanical Base
700 back of mechanical base
702 right face of right side block
704 back face of right side block
706 right face of bottom block
708 lock nut
710, 712 bushings
714 bolt
716 screw
718 nut
720 top face of right side block
722, 724 side block thickness
726, 728 stakes
730, 732 holes in mechanical base bottom block for securing to ground
734 ground surface
736 ground

FIG. 8—Conceptual View of Wing Decoy Actuating System
800 conceptual wing decoy actuating system
802 wing
804 operating handle
806 stake
808, 810, 812 control cable fasteners
821 bolt (bolt pivot) through rod 104 and side blocks
814 pushing handle in (positive input)
816 movement in the actuator caused by 814
818 wing moves down from movement in the actuator 816
820 pulling handle out (negative input)
824 movement in the actuator caused by 820
822 wing moves up from movement in the actuator 824

FIG. 9—Illustrates a User Actuating the Control Cable
900 example use of user actuating control cable
902 inner core moving within outer conduit
904 one hand holding outer conduit
906 one hand holding operating handle

FIG. 10—Perspective View of the Wing Decoy
1000 perspective view of wing decoy in wing up position
1002 user (hunter)

FIG. 11—Back View of Wing Decoy
1100 back view of wing decoy in wing down position

FIG. 12—Front View of Wing Decoy Mechanical Base
1200 front view of mechanical base, wing in down position

FIG. 13—Side View of Wing Decoy
1300 side view of wing decoy, wing in down position
1302 alternate actuator side block face

FIG. 14—Top Down View of Mechanical Base
1400 top down mechanical base while wing in down position

FIG. 15—Top View of Mechanical Base when Wing is in Up Position
1500 top down mechanical base while wing in up position

FIG. 16—Rods Clipped for Storage
1600 mechanical base with rods clipped in for storage
1602 example connector tube
1604 example cotter pin to connect wing rod 104 to the mechanical base
1606, 1608 example clips for storing rods
1610, 1612 actuator side blocks

FIG. 17—Left Side of the Wing Decoy in Stored Position
1700 stored wing decoy
1702 control handle connected to inner core 110 (operating end of control cable)
1704 example handle/protection sleeve 1802 connected to outer core
1706 example strap around control cable and 1704 to keep control cable coiled for storage
1708, 1710 more example straps to keep control cable coiled for storage
1607, 1609 clips for rod storage

FIG. 18—Actuator Protection Sleeve of Wing Decoy
1800 close up of operating end of control cable
1802 handle or protection sleeve on outer conduit 114 portion of control cable for ease of use

FIG. 19—Close Up of Example Use of Cotter Pin Connector
1900 cotter pin connecting wing rod to mechanical base
1604 cotter pin
1602 connector tube

FIG. 20—Right Side of the Wing Decoy in Stored Position
2000 stored wing decoy
2002 example strap
2004 block that works with the right side actuator block to secure the coiled control cable with the wing decoy assembly when in storage.
2006 front of 2004
2008 back of 2004

FIG. 21—Closed Travel Bag for Wing Decoy
2100 closed travel bag
2102 handle at top of bag
2104 main material for bag
2106 bottom of bag

What is claimed is:

1. A hunter-operated and hunter-controllable wing decoy comprising:
a wing having a length and a width;
a mechanical control cable having an outer conduit and an inner core that is moveable within the outer conduit; and
an actuator connectable to the wing and connected to an actuator end of the control cable, and configured to move the wing in relation to the actuator in response to movement between the inner core and the outer conduit of the control cable with respect to one another.

2. The wing decoy of claim 1, wherein the control cable comprises an operating end opposite the actuator end, whereby a hunter causes movement of the wing by, at the operating end of the control cable, moving the inner core of the control cable with respect to the outer conduit, thereby causing the actuator to move the wing in response to the hunter causing movement between the inner core and the outer conduit of the control cable.

3. The wing decoy of claim 1, wherein the wing comprises triangular-shaped material or material in a shape of a bird's wing.

4. The wing decoy of claim 1, wherein the wing comprises a semi-rigid material.

5. The wing decoy of claim 1, wherein the wing comprises a closed cell foam.

6. The wing decoy of claim 1, wherein the wing comprises an EPE foam.

7. The wing decoy of claim 1, wherein a rod or a plurality of interconnectable rod portions connects the wing to the actuator.

8. The wing decoy of claim 1, wherein the actuator pivotally moves the wing up and down or in a back and forth motion in response to moving the inner core in relation to the outer conduit of the control cable.

9. The wing decoy of claim 1, wherein the actuator is configured to move the wing in response to movement of the inner core in relation to the outer conduit of the control cable without the actuator anchored to a surface or anchored to ground situated beneath the actuator.

10. The wing decoy of claim 9, wherein the actuator is anchored to a surface or anchored to ground situated beneath the actuator by one or more stakes.

11. The wing decoy of claim 1, wherein the control cable comprises a push-pull mechanical control cable or a push-pull throttle cable.

12. The wing decoy of claim 11, wherein the inner core of the control cable is made of a solid non-stranded material.

13. The wing decoy of claim 1, wherein the wing is configured to flex along its length and/or width dimensions when moved up and down or back and forth in response to movement between the inner core and the outer conduit of the control cable, so as to mimic wing motion of a bird.

14. The wing decoy of claim 1, wherein the wing is repeatably detachable by a hunter from one or more rod portions connecting the wing to the actuator, the wing is repeatably foldable and/or rollable by the hunter so as to reduce the wing's length and/or width when in a folded and/or a rolled up orientation, the one or more rod portions are repeatably detachable by the hunter from the actuator, and the control cable is flexible to allow for repeatedly rolling or coiling the control cable by the hunter into a rolled up orientation with the actuator.

15. The wing decoy of claim 14, wherein the wing and the one or more rod portions used to connect the wing to the actuator are configured to disassemble from one another into a collapsed secured unit with the actuator and with the control cable in the rolled up orientation, the collapsed secured unit configured for carrying by the hunter.

16. A method of using a hunter-operated and hunter-controllable wing decoy comprising:
placing a collapsed secured wing decoy on a ground surface, the collapsed secured wing decoy comprising the wing decoy as in claim 1;
unfolding and/or unrolling the wing;
unrolling the mechanical control cable along the ground surface so that the control cable connected thereto at an actuator end of the control cable extends away from the actuator to an operator end of the control cable;
attaching the wing to the actuator, the unrolled control cable with actuator and wing attached thereto comprising an assembled hunter-operated and hunter-controllable wing decoy; and
moving, by a hunter operating the control cable at the operator end of the control cable, the inner core of the control cable with respect to the outer conduit of the control cable so as to move the wing in an up and down or back and forth motion to mimic a motion of a wing of a bird.

17. The method of using the wing decoy of claim 16, further comprising:
placing, proximate to the assembled hunter-operated and hunter-controllable wing decoy, a plurality of static wing decoys, wherein each of the plurality of static wing decoys comprises triangular-shaped material or material in a shape of a bird's wing.

18. A kit of components for a hunter-operated and hunter-controllable wing decoy comprising:
a wing having a length and a width; and
a mechanical control cable having an outer conduit and an inner core that is moveable within the outer conduit, with an actuator connectable to the wing and connected to an actuator end of the control cable, the actuator and control cable configured to move the wing in relation to the actuator in response to movement between the inner core and the outer conduit of the control cable with respect to one another.

19. The kit of claim 18 further comprising:
a rod or a plurality of interconnectable rod portions configured to connect the wing to the actuator.

20. The kit of claim 19 further comprising:
a bag sized to enclose and retain the wing when folded and/or rolled up to reduce its length and/or width, the actuator with the control cable in a rolled up or coiled orientation, and the rod or the plurality of interconnectable rod portions when disassembled from connecting the wing to the actuator.
